(19) United States
(12) Patent Application Publication
(10) Pub. No.: US 2019/0037954 A1
(43) Pub. Date: Feb. 7, 2019

(54) Hard Hat Assembly

(71) Applicant: Guardhat, Inc., Detroit, MI (US)

(72) Inventors: Steven Friedman, Concord, CA (US); Mikhail Zhavoronkov, Northville, MI (US)

(73) Assignee: Guardhat, Inc., Detroit, MI (US)

(21) Appl. No.: 16/155,652

(22) Filed: Oct. 9, 2018

Related U.S. Application Data
(63) Continuation-in-part of application No. 15/150,384, filed on May 9, 2016.
Application No. 15/150,384 is a continuation-in-part of application No. 14/883,157, filed on Oct. 14, 2015, now Pat. No. 9,538,801.
Application No. 14/883,157 is a division of application No. 14/590,596, filed on Jan. 6, 2015, now Pat. No. 9,177,458.
Application No. 14/590,596 is a division of application No. 14/517,385, filed on Oct. 17, 2014, now Pat. No. 9,013,297.

(51) Int. Cl. A42B 3/04; H04Q 9/00; G08B 25/10; G08B 25/01; G08B 25/00; G08B 21/02; G08B 21/04

(52) U.S. Cl. CPC A42B 3/046; H04Q 9/00; G08B 25/10; G08B 25/014; G08B 25/016; G08B 21/02; G08B 21/0446; G08B 21/0453; G08B 25/009

(57) ABSTRACT

A hard hat assembly is designed to be worn on a head of a user. The hard hat assembly includes a helmet shaped to cover an upper portion of the head of the user. The helmet defines a primary opening to receive the head therein. The helmet also defines a periphery about the primary opening. A brim extends outwardly from the helmet adjacent the periphery to a brim outer edge. A brim panel is removably securable to the brim and, along with the brim, creates one or more compartments between the brim and the brim panel. An electrical circuit is fixedly secured within the compartments.

This patent application is a continuation-in-part of co-pending patent application having U.S. Ser. No. 15/150,384, which is a continuation-in-part of U.S. Pat. No. 9,538,801, which is a division of U.S. Pat. No. 9,177,458, which is a division of U.S. Pat. No. 9,013,297, filed on Oct. 17, 2014, the disclosures of which are expressly incorporated herein by reference.

### BACKGROUND OF THE INVENTION

### 1. Field of the Invention

The invention relates to hard hat assemblies. More particularly, the invention relates to hard hat assemblies and the construction thereof when the hard hat assembly includes electronic capabilities such as sensing conditions exterior of the hard hat assembly and communicating to locations remote of the hard hat assembly.

### 2. Description of the Related Art

Collecting data and sensing the surrounding environment of workers allows enhanced safety and the optimization of efficiency in the workforce. Equipping workers with sensing equipment is difficult because workers do not want to carry any extra load or have the extra equipment inhibit their ability to do their jobs. Extra weight on the uniform of a worker or the excess weight of a new system on a particular portion of a body will reduce the buy-in by the worker as to the advantages acquired by using the sensing equipment. As such, there is a need to maximize sensing and communicating abilities while minimizing the additional weight and any disproportionate effect on any single part of the user's body.

### SUMMARY OF THE INVENTION

A hard hat assembly is designed to be worn on the head of a user. The hard hat assembly includes a helmet shaped to cover an upper portion of the head of the user. The helmet defines a primary opening to receive the head therein. The helmet also defines a periphery about the primary opening. A brim extends outwardly from the helmet adjacent the periphery to a brim outer edge. A brim panel is removably securable to the brim and, along with the brim, creates a compartment between the brim and the brim panel. An electrical circuit is fixedly secured within the compartment.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view of the top side of one embodiment of the invention;

FIG. 2 is a perspective view of the underside of the hard hat assembly with a brim panel removed therefrom;

FIG. 3 is a bottom view of the invention the brim panel removed therefrom;

FIG. 4 is a perspective view of the underside of the invention with a power strip installed;

FIG. 5 is an exploded view of a number of circuit boards designed according to the invention;

FIG. 6 is an exploded view of the embodiment shown in FIG. 5 with power strip connectors affixed to the circuit boards;

FIG. 7 is an exploded view of the embodiment shown in FIG. 6 with the addition of a power strip;

FIG. 8 is a front perspective view of the invention;

FIG. 9 is a perspective view of the underside of the invention, partially cut away, showing the brim panel attached to the hard hat assembly;

FIG. 10 is a top perspective of the invention showing the location of some internal constructs; and

FIG. 11 is an exploded side view of the invention with the battery compartment visible.

### DETAILED DESCRIPTION OF THE INVENTION

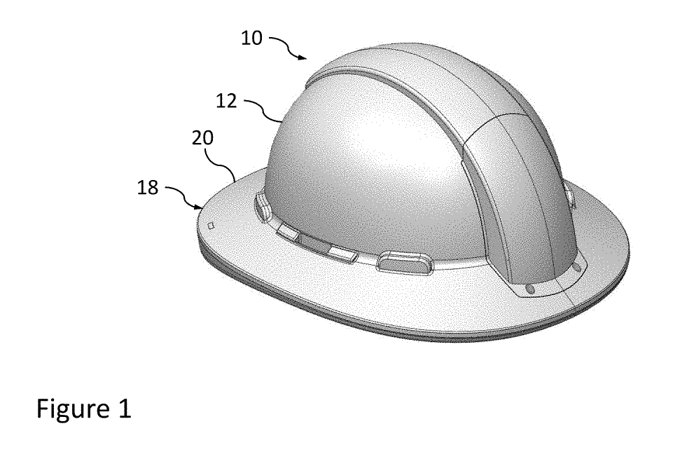

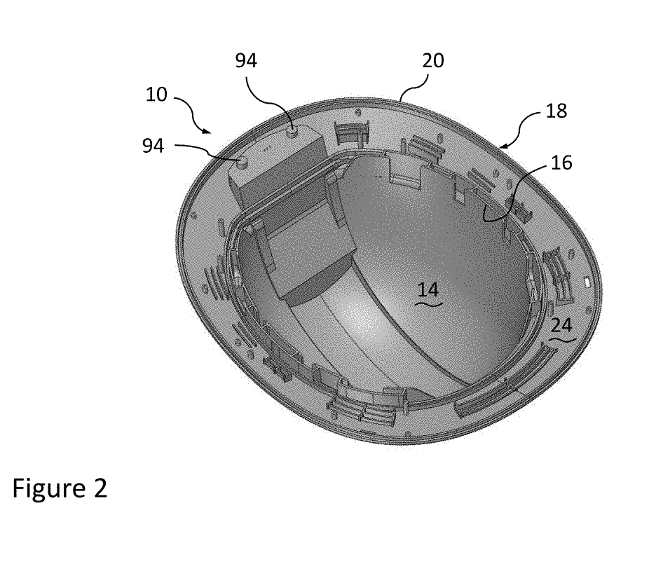

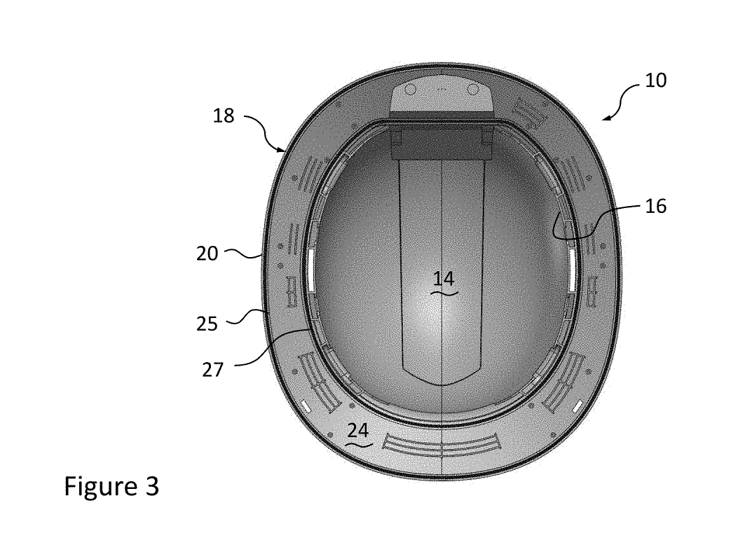

Referring to FIG. 1, a hard hat assembly is generally indicated at 10. The hard hat assembly 10 is worn on the head of a user (not shown). The hard hat assembly 10 includes a helmet or shell 12, which is shaped to cover an upper portion of the head of the user. The helmet 12 includes a primary opening 14 to receive the head therein. The primary opening 14 defines a periphery 16 (best seen in FIGS. 2 and 3).

A brim, generally shown at 18, extends outwardly from the helmet 12 adjacent the periphery 16. The brim 18 extends out to a brim outer edge 20. Traditionally, the brim 18 of a hard hat assembly 10 is designed to provide shade and protect the user's head and face by deflecting debris away from the user's head. In this embodiment, the brim 18 performs these functions as well.

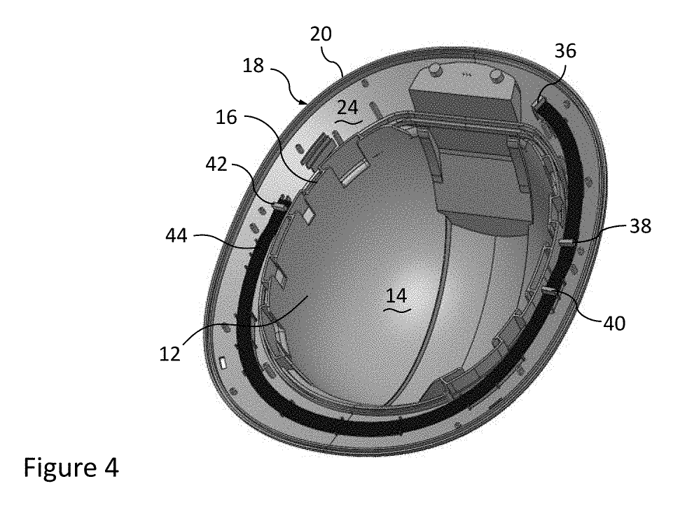

A brim panel 22 is removably secured to the brim 18 creating a compartment 24 (best seen in FIG. 4) between the brim 18 and the brim panel 22. In the preferred embodiment, the compartment 24 extends between the periphery 16 and the brim outer edge 20. It should be appreciated by those skilled in the art that the compartment 24 may extend through a distance that is merely a portion of the distance between the periphery 16 and the outer edge 20. In addition, the compartment 24 may not extend completely around the entire periphery 16 of the brim 18. In these instances, there will be a plurality of compartments 24 spaced equally distantly around the periphery 16. It should be appreciated by those skilled in the art that such compartments 24 may be spaced about the periphery 16 based on the contents therein and the weight associated with those contents. By way of example only, one of the compartments 24 may be positioned in the back of the helmet 12 and two other compartments 24 may be equally distantly spaced but near the front of the helmet 12 to allow the hard hat assembly 10 to be balanced when resting on the head of the user.

A gasket 25 extends along an edge of the brim panel 22 to seal the compartment 24. In the embodiment shown (best seen in FIG. 3), there are two gaskets 25, 27 that are used to seal the compartment 24. It should be appreciated by those skilled in the art that the invention may include a plurality of gaskets depending on the number of brim panels 22 incorporated into the design of the hard hat assembly 10 to create a plurality of compartments 24.

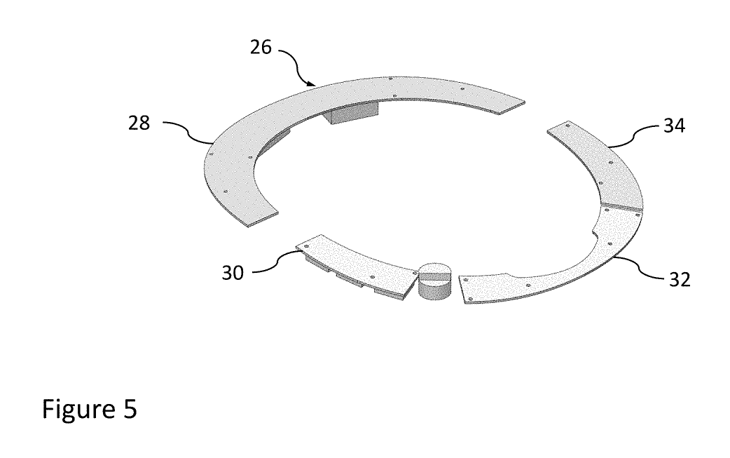

The compartment 24 (or plurality of compartments 24) will have electrical circuits, generally indicated at 26 fixedly secured therein. The electrical circuits 26 are best seen in FIGS. 5 through 7. The electrical circuits 26 will include a printed circuit board assembly 28. In the embodiment shown in the Figures, there will be at least four printed circuit board assemblies 28, 30, 32, 34. Each of these printed circuit board assemblies 28-34 may have dedicated functions. In the example shown in the Figures, the first printed circuit board assembly 28 is a carrier board. The carrier board 28 may include main processing unit, storage memory, real time clock, audio/video system (including microphones, speakers, camera, etc.), Wi-Fi/cellular communication, peer-to-peer networking, and interfaces to other boards and devices. This board 28 controls all other systems and provides telemetry/communications and media capabilities. The second printed circuit board assembly 30 is a sensor board designed to house and control sensors on the printed circuit board assembly 30 and/or located throughout the hard hat assembly 10. Although not shown, some of the sensors may be secured to a suspension band and electrically connected to the second printed circuit board assembly 30 through an electrical port extending through the anchor system of the suspension band, as discussed in U.S. patent application Ser. No. 15/150,384, the disclosure of which is incorporated herein by reference.

The third printed circuit board assembly 32 is the power board designed to receive power, either from a battery or from a plug-in connection, and distribute and/or transform the power to the other printed circuit board assemblies 28, 30, 34. The fourth printed circuit board assembly 34 is a tracking board and includes devices to track the location of the hard hat assembly. Such tracking devices may include Global Navigation Satellite System (GPS, GLONAS, BDS, Galileo, etc.) based positioning devices, radio frequency (UWB, Wi-Fi, ZigBee, BLE, etc.) based positioning devices, inertial measurement unit (magnetic field-based positioning, fall and acceleration detection, dead reckoning, etc.), barometer (height detection), optical positioning devices, and any combination of these technologies. It should be appreciated by those skilled in the art that these printed circuit board assemblies 28, 30, 32 may be organized in varying sequences without adding to the inventive concept.

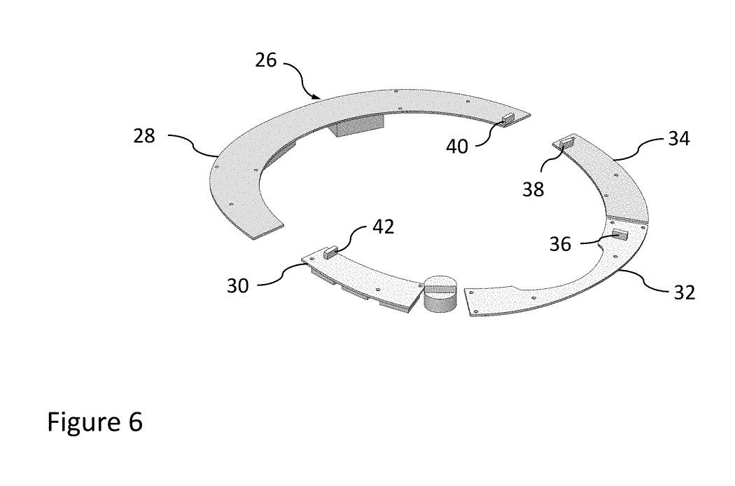

Referring specifically to FIG. 6, power strip connectors 36, 38, 40, 42 extend out from the printed circuit board assemblies 28, 30, 32, 34, respectively. In the embodiment shown, the power strip connectors 36, 38, 40, 42 all extend out from their respective printed circuit board assemblies 28, 30, 32, 34 in the same direction. In the embodiment shown, the power strip connectors 36, 38, 40, 42 extend in a direction that is toward the brim 18, which is away from the brim panel 22. In a normal operation, the power strip connectors 36, 38, 40, 42 would generally extend upwardly.

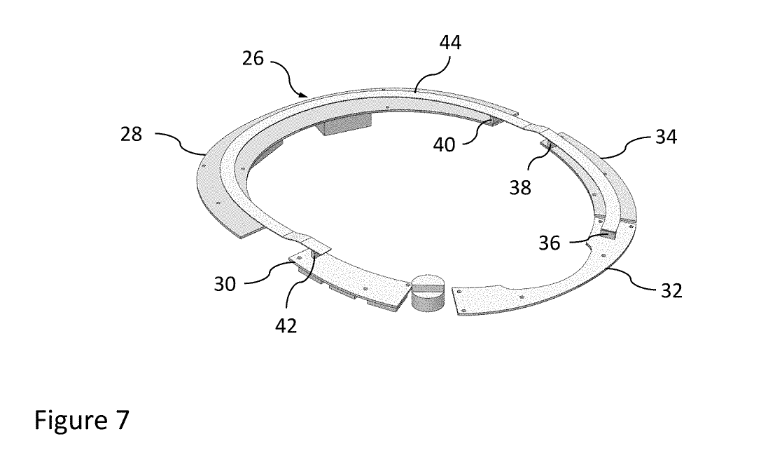

A power bus 44 is initially connected to the power board 32 using the power strip connector 40 fixedly secured thereto (best seen in FIG. 7). The power bus extends around the brim 18 between the brim outer edge 20 and the periphery 16 of the helmet 12. The power bus 44 includes a ribbon of electrical conductors that will connect the power received and transformed by the power board 32 to all of the other printed circuit board assemblies 28, 30, 34 to provide power to each of these printed circuit board assemblies 28, 30, 34. The power bus 44 also provides power to any sensors or electronic devices (not shown) that may be directly connected to the power board 32 and not to any of the other printed circuit board assemblies 28, 30, 34. These devices would be dispersed throughout the helmet 12 or attached to the helmet 12 but not controlled by the other printed circuit board assemblies 28, 30, 34.

The power bus 44 is connected to each of the power strip connectors 38, 40, 42. The power bus 44 is designed such that the power supply to each of the printed circuit board assemblies 28, 30, 32, 34 are done so independently of each other. This allows the operation of each of these printed circuit board assemblies 28, 30, 32, 34 without requiring each of the other printed circuit board assemblies 28, 30, 32, 34 to be operating.

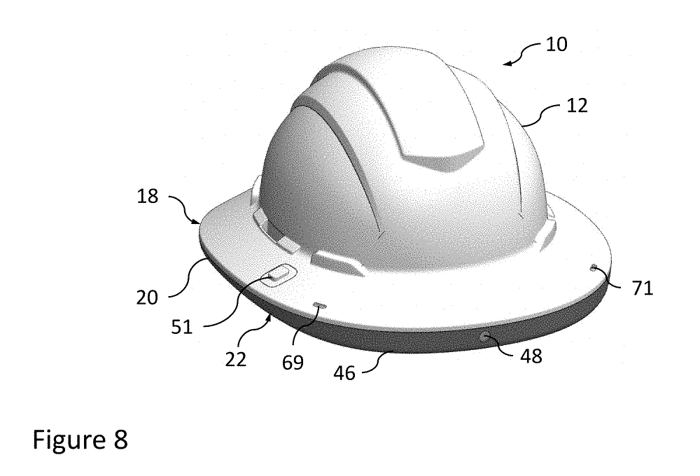

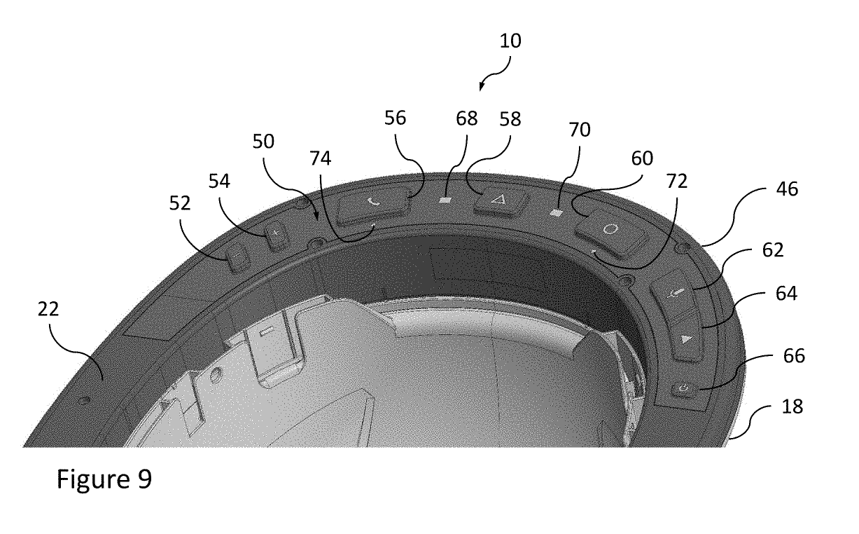

Referring to FIG. 9, the brim panel 22 is shown to include a forward-facing surface 46. The forward-facing surface 46 allows for more space within the compartment 24 (shown in FIGS. 1-4) by allowing the brim panel 22 two extend down lower from the brim 18 than would otherwise be possible. The forward-facing surface 46, and any inward facing surface(s) (none shown) facilitate the increased capacity within the compartment 24. The forward-facing surface 46 also provides a surface against which or through which electronic components may be mounted within the compartment 24. In particular, the forward-facing surface 46 includes a “window” 48 (best seen in FIG. 8) through which a camera (not shown) may be directed. Thus, the forward-facing surface 46 allows a camera to be mounted within the compartment 24 so that it is not exposed to the environment directly outside the hard hat assembly 10 but allows the camera to operate properly with a useful orientation as its optical sensor is pointed through the window 48. The forward-facing surface 46 may extend around the entire brim outer edge 20.

Extending generally perpendicular to the forward-facing surface 46 is a control surface 50. In the embodiment shown in FIG. 9, the control surface 50 is under the brim 18 when the hard hat assembly 10 being worn by a user (opposite orientation shown in FIG. 9). The control surface 50 has a plurality of control buttons 52, 54, 56, 58, 60, 62, 64, 66 to control various electronic components housed within the compartment 24 of the hard hat assembly 10. They include the power button 66, the push-to-talk button 62, the call button 56, volume adjustment buttons 52, 54, and the like. It should be appreciated by those skilled in the art that there may be more or fewer buttons depending on the functionality incorporated into the hard hat assembly 10.

The control surface 50 may include light openings 68, 70, 72, 74. These light openings 68, 70, 72, 74 allow light to exit from behind the control surface 50. The light openings 68, 70 may provide ambient light, event and device status communication or navigation assistance for the wearer of the hard hat assembly 10. Light openings 72, 74 may provide guidance for the wearer to particular control buttons 56, 60 to help identify those buttons. Lighting devices, such as light sources (e.g., LEDs) or wave guides that are disposed adjacent the light openings 68, 70, 72, 74 provide the light that will be emitted from the light openings 68, 70, 72, 74. Transparent coverings, translucent coverings or lenses (none shown) may cover light openings 68, 70, 72, 74, as is well known in the art.

The helmet 12 may include light openings 69, 71 and a control button 51 (best seen in FIG. 8). The light openings 69, 71 may provide guidance or communication to nearby users. Transparent coverings, translucent coverings, or lenses (none shown) may cover light openings 69, 71. The control button 51 may be used to control an image capture device directed through window 48. It should be appreciated by those skilled in the art that there may be more or fewer light openings and buttons depending on the functionality incorporated into the hard hat assembly 10.

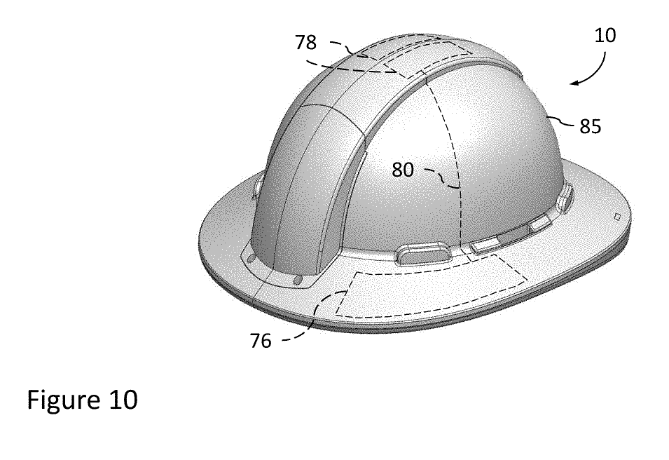

Referring to FIG. 10, the hard hat assembly 10 includes an antenna 76, shown in phantom. The antenna 76 provides the ability for the signals created by the electrical circuits 26 to be transmitted to locations remote thereof. The antenna 76 also receives signals generated remotely from the hard hat assembly 10 to provide the necessary communications between the wearer of the hard hat assembly 10, those peer hard hat assemblies (not shown) located nearby or similarly tasked, and a communication control center that may be included in the deployment of the hard hat assembly 10.

The antenna 76 is designed to maximize its range. To that end, a loop portion 78 of the antenna 76 is routed using antenna arm 80 to the top of the helmet 12. The top loop portion 78 of the antenna 76 provides the wearer of the hard hat assembly 10 maximum gain in signal strength by placing the top loop portion as high as possible on the wearer to remove as many obstacles, including the wearer's body, from interfering with signal reception and transmission.

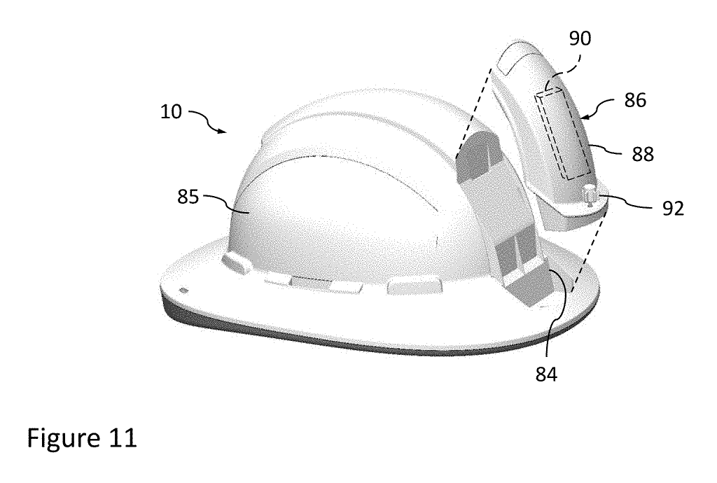

Referring to FIG. 11, the hard hat assembly 10 includes a battery port 84 on the exterior or outer side 85 of the helmet 12. The battery port 84 receives a battery cartridge, generally shown at 86, therein. The battery cartridge 86 includes a housing 88 that is designed to house the battery 90 and secure the battery 90 in place outside the helmet 12 in a manner that allows the battery 90 to provide power to the electrical circuits 26. The battery cartridge 86 extends along a portion of a midline of the helmet 12 to balance the helmet 12 when being worn. In addition, the battery cartridge 86 and the battery port 84 are in the back of the helmet 12 to help balance many of the electronic components and circuits that are disposed adjacent the forward-facing surface 46. A securing device 92 is used to selectively secure the battery cartridge 86 within the battery port 84. The securing device 92 will allow for the quick removal and replacement of battery cartridges 86 should a battery 90 need to be charged or replaced. In the embodiment shown, the securing device 92 is a thumb screw. Cartridge stud reliefs 94 (best seen in FIG. 2) help align the battery cartridge 86 within the battery port 84 by receiving cartridge studs (not shown) therein when the battery cartridge 86 is positioned in the battery port 84 to be secured therein.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. A hard hat assembly to be worn on a head of a user, said hard hat assembly comprising:
a helmet shaped to cover an upper portion of the head of the user, said helmet having a primary opening to receive the head therein and defining a periphery about said primary opening;
a brim extending outwardly from said helmet adjacent said periphery to a brim outer edge;
a brim panel removably securable to said brim creating a compartment between said brim and said brim panel; and
an electrical circuit fixedly secured within said compartment.

2. A hard hat assembly as set forth in claim 1 wherein said brim extends outwardly from said helmet adjacent all of said periphery.

3. A hard hat assembly as set forth in claim 1 wherein said brim panel creates said compartment adjacent all of said brim.

4. A hard hat assembly as set forth in claim 1 including a power bus extending along all of said compartment supplying power throughout said compartment.

5. A hard hat assembly as set forth in claim 4 including a plurality of circuit boards, each extending along a portion of said power bus within said compartment.

6. A hard hat assembly as set forth in claim 5 wherein each of said plurality of circuit boards is connected to said power bus along said power bus.

7. A hard hat assembly as set forth in claim 5 wherein each of said plurality of circuit boards is mounted to said brim independently of each other.

8. A hard hat assembly as set forth in claim 7 wherein each of said plurality of circuit boards is mounted along said brim in a manner to balance said hard hat assembly on the head of the user.

9. A hard hat assembly as set forth in claim 1 wherein said brim panel includes a light source to generate a visual signal.

10. A hard hat assembly as set forth in claim 1 including a seal extending between said brim and said brim panel.

11. A hard hat assembly as set forth in claim 10 wherein said seal is a gasket.

12. A hard hat assembly as set forth in claim 11 wherein said gasket seals said compartment from an ambient environment.

13. A hard hat assembly as set forth in claim 1 including an antenna defining a top antenna loop secured to a top portion of said helmet.

14. A hard hat assembly as set forth in claim 1 including a battery port formed in said helmet on an outer side thereof.

15. A hard hat assembly as set forth in claim 14 including a battery cartridge to be removably received by and secured within said battery port.

16. A hard hat assembly as set forth in claim 15 wherein said brim includes a cartridge stud relief to assist in the orienting of said battery cartridge as said battery cartridge is inserted into said battery port.

17. A hard hat assembly to be worn on a head of a user, said hard hat assembly comprising:
a helmet shaped to cover an upper portion of the head of the user, said helmet having a primary opening to receive the head therein and defining a periphery about said primary opening;
a brim extending outwardly from said helmet adjacent said periphery to a brim outer edge;
a brim panel removably securable to said brim creating a compartment between said brim and said brim panel; and
a plurality of circuit boards fixedly secured within said compartment mounted along said brim in a manner to balance said hard hat assembly on the head of the user.

18. A hard hat assembly as set forth in claim 13 wherein said brim extends outwardly from said helmet adjacent all of said periphery.

19. A hard hat assembly as set forth in claim 13 wherein said brim panel creates said compartment adjacent all of said brim.

20. A hard hat assembly as set forth in claim 13 including a power bus extending along all of said compartment supplying power throughout said compartment.

21. A hard hat assembly to be worn on a head of a user, said hard hat assembly comprising:
a helmet defining a midline and shaped to cover an upper portion of the head of the user, said helmet having a primary opening to receive the head therein and defining a periphery about said primary opening;
a brim extending outwardly from said helmet adjacent said periphery to a brim outer edge;
a brim panel removably securable to said brim creating a compartment between said brim and said brim panel;
a plurality of circuit boards fixedly secured within said compartment mounted along said brim in a manner to balance said hard hat assembly on the head of the user; and
a battery port formed in said helmet on an outer side thereof positioned along said midline of said helmet and disposed on a rearward side of said helmet.

22. A hard hat assembly as set forth in claim 21 including a battery cartridge to be removably received by and secured within said battery port.

23. A hard hat assembly as set forth in claim 22 wherein said brim includes a cartridge stud relief to assist in the orienting of said battery cartridge as said battery cartridge is inserted into said battery port.

24. A hard hat assembly as set forth in claim 23 wherein said battery cartridge includes a securing device to secure said battery cartridge within said battery port.

25. A hard hat assembly as set forth in claim 24 wherein said securing device is a thumb screw.
